(19) United States
(12) Patent Application Publication
(10) Pub. No.: US 2014/0122757 A1
(43) Pub. Date: May 1, 2014

(54) VEHICLE DATA ABSTRACTION AND COMMUNICATION

(71) Applicant: CLOUDCAR, INC., Los Altos, CA (US)

(72) Inventors: Peter Barrett, Palo Alto, CA (US); Konstantin Othmer, Los Altos, CA (US); Bruce Leak, Los Altos hills, CA (US)

(73) Assignee: CLOUDCAR, INC., Los Altos, CA (US)

(21) Appl. No.: 13/735,852

(22) Filed: Jan. 7, 2013

Related U.S. Application Data
(63) Continuation-in-part of application No. 13/664,212, filed on Oct. 30, 2012.

(51) Int. Cl. G06F 13/36

(52) U.S. Cl. CPC G06F 13/36
USPC 710/107

(57) ABSTRACT

An example embodiment includes an abstraction device including a mapping platform, a vehicle transceiver, and a mobile device transceiver. The mapping platform is configured to convert input data messages formatted in a vehicle-specific format to output data messages formatted in a standard mobile device format. The mapping platform is further configured to convert input data messages formatted in the standard mobile device format to output data messages in the vehicle-specific format. The input data messages may have any of multiple data message types, which are communicated from multiple mobile device subsystems, and multiple vehicle subsystems. The vehicle transceiver is configured to transmit the output data messages formatted in the vehicle-specific format to a vehicle via a controller area network (CAN) bus of the vehicle. The mobile device transceiver is configured to transmit the output data messages formatted in the standard mobile device format to a mobile device.

### CROSS-REFERENCE TO A RELATED APPLICATION

This patent application is a continuation-in-part of U.S. patent application Ser. No. 13/664,212, filed Oct. 30, 2012, which is incorporated herein by reference.

### BACKGROUND

1. Field

Embodiments of the invention relate to communication of data between mobile devices and Controller Area Network (CAN) buses.

2. Relevant Technology

As the complexity of mechanized systems such as automobiles, industrial equipment, and medical equipment increases, the variety and utility of systems and devices that electronically interface with components included in the mechanized systems has also increased. For example, since the 1980s, most new automobiles include Electronic Control Units (ECUs), which are increasing in number in new vehicles each year. For instance, a Powertrain Control Module (PCM) is an ECU associated with an automobile engine. An ECU typically includes a microprocessor that receives input from sensors associated with a particular vehicle subsystem and has software and hardware that allows components of the subsystem to be controlled.

ECUs communicate with each other and with other components of the automobile using one or more CAN buses. For example, a PCM is capable of communicating over a CAN bus to control automatic transmissions, traction control systems, and other systems in the vehicle. In general, the CAN bus is a multi-master broadcast serial bus that transmits data between ECUs. Modern automobiles also include an On Board Diagnostics (OBD) connector, such as those defined by the OBD II specification, that enables the CAN bus to be accessed. The OBD connector can thereby permit diagnostics information to be accessed and to enable software in ECUs in communication with the CAN bus to be upgraded. Many ECUs and associated data are proprietary to a particular vehicle or subsystem manufacturer as opposed to being defined by industry standards.

Some devices, such as mobile phones and tablet computers, include electronically interfacing components or subsystems that interface with systems outside the device. The interfacing components or the systems outside the device may differ in software languages, data formats, protocols, addressing schemes, etc. The differing software languages, data formats, protocols, and addressing schemes may result in incompatibility between the interfacing components or between the device and the systems outside the device, and make it difficult for outside systems to interface with these systems. To enable communication between interfacing components or between the device and the systems outside the device, an Application Programming Interface (API) may be developed. An API generally includes one or more specifications, which communicate information pertaining to program routines or sub-routines, structure or organization of data, classes of objects, and functions of variables. The API may include libraries of programming languages, standards, or documentation published by a vendor.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF SOME EXAMPLE EMBODIMENTS

This Summary introduces a selection of concepts in a simplified form that are further described below. This Summary is not intended to identify key features or essential characteristics of the claimed subject matter, nor is it intended to be used as an aid in determining the scope of the claimed subject matter.

An example embodiment includes a data abstraction and communication device (hereinafter “abstraction device”) configured to communicate a subset of data between a vehicle and a mobile device. The data may be received by the abstraction device as input data messages from the vehicle and/or from the mobile device. The input data messages can represent automotive events which are communicated to the abstraction device from a CAN bus of the vehicle. Generally, the automotive events represent a state or change in state of a vehicle component or a vehicle subsystem.

To enable communication between the vehicle and the mobile device, the abstraction device converts input data messages formatted in a vehicle-specific format to output data messages formatted in a standard mobile device format. The input data messages formatted in the vehicle-specific format may include any of multiple data message types, which are communicated from multiple vehicle components or vehicle subsystems. The data message types communicated from the multiple vehicle subsystems can include, for example, application data messages, control data messages, basic connectivity data messages, and power management data messages.

Additionally, the abstraction device converts input data messages formatted in the standard mobile device format to the vehicle-specific format. The input data messages formatted in the standard mobile device format may include any of multiple data message types, which are communicated from multiple mobile device subsystems. The data message types communicated from the multiple mobile device subsystems can include, for example, video data messages, audio data messages, application data messages, basic connectivity data messages, remote procedure call (hereinafter “RPC”) messages and application projection messages. RPC messages are configured to cause a subroutine or a procedure to be executed to affect a condition of a vehicle component or a vehicle subsystem. Application projection messages include projections of mobile applications installed on the mobile device onto a display in the vehicle.

The abstraction device also includes a vehicle transceiver configured to transmit the output data messages formatted in the vehicle-specific format to the CAN bus of the vehicle and a mobile device transceiver configured to transmit the output data messages formatted in the standard mobile device format to the mobile device.

The abstraction device can perform the conversion of data messages on a one-to-one mapping basis and/or can perform conversions that are more complex. To perform the conversions that are more complex, the abstraction device can include an algorithmic logic unit (hereinafter “ALU”) and a state machine. The ALU is configured to perform algorithmic instructions on some input data messages. The ALU generates an ALU output message that is converted to an output data message formatted in the vehicle-specific format or the standard mobile device format.

The state machine is configured to collect some input data messages and to track a state of an event. When the state of the event occurs as indicated by the input data messages, the state machine is configured to communicate a state machine output message representing that the state of the event has occurred. The state machine output message is converted to an output data message formatted in the vehicle-specific format or the standard mobile device format.

In another embodiment, the abstraction device includes a subscription module, a filter, a mapping platform, a mobile device transceiver, a vehicle transceiver, and a certification module. The subscription module is configured to enable selection of one or more subsets of information represented by data messages communicated between a vehicle and a mobile device. The filter is configured to receive the selection from the subscription module and to enable bi-directional filtering of the data messages communicated between the vehicle and the mobile device. The mapping platform is configured to convert input data messages from a vehicle-specific format to output data messages in a standard mobile device format and to convert input data messages from the standard mobile device format to output data messages formatted in the vehicle-specific format.

The certification module is configured to verify read privileges or write privileges of the mobile device. The certification module interfaces with the subscription module and the filter to further restrict communication of the data messages between the mobile device and the vehicle. For instance, a determination of which data messages are transmitted to the mobile device can be based on the selection made in the subscription module and a read privilege or a write privilege of the mobile device. The read privilege or the write privilege is verified by the certification module.

The mobile device transceiver is configured to transmit a subset of the output data messages formatted in the standard mobile device format from the abstraction device to the mobile device. Likewise, the vehicle transceiver is configured to transmit a second subset of the output data messages formatted in the vehicle-specific format from the abstraction device to a CAN bus of the vehicle.

Another example embodiment includes a method of communicating data messages between a mobile device and a vehicle. The method includes receiving a first set of input data messages from the vehicle which are formatted in a vehicle-specific format and receiving a second set of input data messages from the mobile device which are formatted in a standard mobile device format. The method also includes converting the first set of input data messages from the vehicle-specific format to data messages formatted in a standard mobile device format defined by an application programming interface (hereinafter “API”) and converting the second set of input data messages from the standard mobile device format to data messages formatted in the vehicle-specific format. A subset of the data messages formatted in the standard mobile device format is transmitted to the mobile device. Also, a subset of the data messages formatted in the vehicle-specific format is transmitted to the vehicle. As already mentioned, the conversion of input data messages to output data messages may be a one-to-one mapping and/or more complex algorithm.

The method also includes collecting a subset of the input data messages and tracking a state of an event. When the state of the event occurs as indicated by the subset of the input data messages, a state machine output message representing that the state of the event has occurred is generated. The state machine output message is converted to an output data message.

The method also includes receiving a second subset of the input data messages. Algorithmic instructions are performed on the second subset of the input data messages. From the performance of the algorithmic instructions, an ALU output message is generated that is converted to an output data message.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

Embodiments will be described and explained with additional specificity and detail through the use of the accompanying drawings in which:

FIG. 1 illustrates a block diagram of an example data abstraction and communication system (hereinafter “system”) in which embodiments described herein may be implemented;

FIG. 2 illustrates an example software stack that can be implemented in the system of FIG. 1;

FIG. 3 illustrates some example output data messages representing automotive events that may be communicated in the system of FIG. 1; and

FIG. 4 is a flow chart of an example method of communicating data messages between a mobile device and a vehicle, arranged in accordance with at least some embodiments described herein.

### DETAILED DESCRIPTION OF SOME EXAMPLE EMBODIMENTS

Reference will now be made to the figures wherein like structures will be provided with like reference designations. The drawings are diagrammatic and schematic representations of example embodiments and, accordingly, are not limiting of the scope of the claimed subject matter, nor are the drawings necessarily drawn to scale.

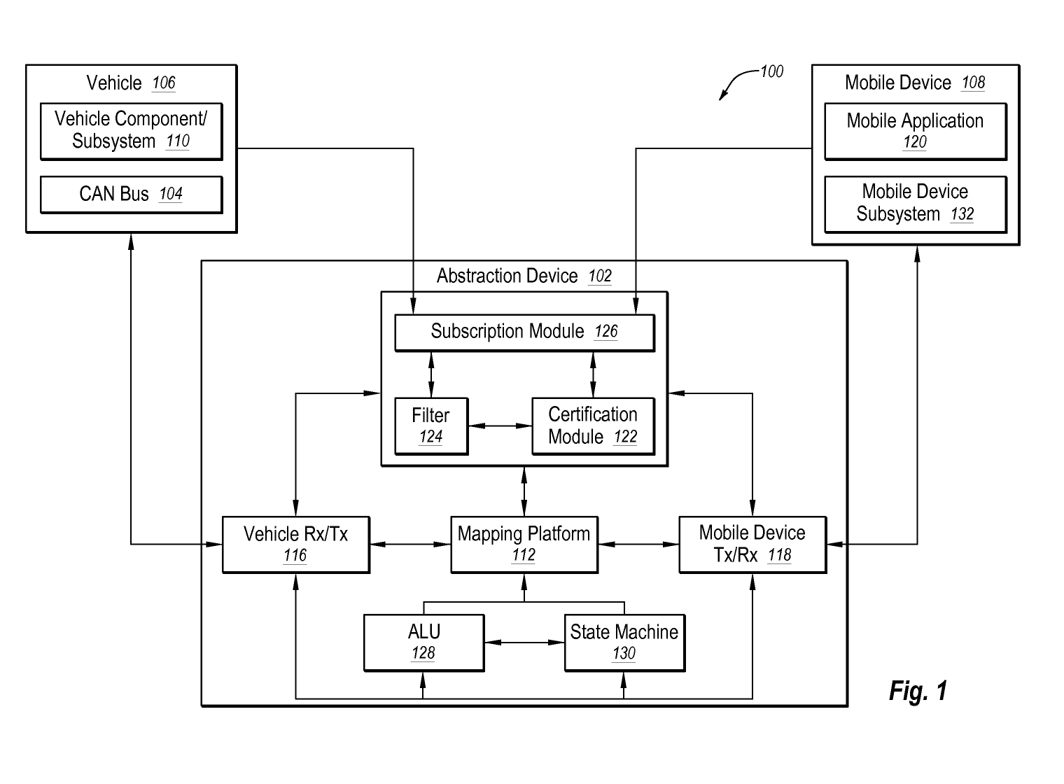

FIG. 1 illustrates a block diagram of an example data abstraction and communication system (hereinafter “system”) 100 in which some embodiments described herein may be implemented. Specifically, FIG. 1 illustrates some details of an example layout and example internal communication interface between components (e.g., 128, 130, 126, 124, 116, 122, 112, and 118) included in an example data abstraction and communication device (hereinafter “abstraction device”) 102.

Generally, the abstraction device 102 is configured to communicate data messages (described below), some subset thereof, or some combination thereof, between a vehicle 106 and a mobile device 108. The abstraction device 102 is adapted to interface with and enable communication of the data messages between a controller area network (hereinafter “CAN”) bus 104 of the vehicle 106 and a mobile application 120 and/or a mobile device subsystem 132 of the mobile device 108.

The CAN bus 104 can alternatively or additionally include any bus used in a vehicle 106 for communicating messages between vehicle components or vehicle subsystems including other standards such as media oriented systems transport (MOST), local interconnect network (LIN), inter-integrated circuit (I2C), and Ethernet.

Additionally as depicted in FIG. 1, the system 100 includes the vehicle 106 and the mobile device 108. However, this depiction is not meant to be limiting. The system 100 described herein can be used with substantially any mechanized system that uses the CAN bus 104 or similar component interface. These mechanized systems can include, but are not limited to, industrial equipment, medical equipment, automobiles, boats, trucks, etc. It should be appreciated, with the benefit of this disclosure, that descriptions referencing the term “vehicle” can extend to any of these mechanized systems. Additionally, the mobile device 108 can include, but is not limited to, a mobile phone, a smartphone, a personal digital assistant, a laptop computer, a tablet computer, or other mobile communication device. The system 100 can include more than one mobile device 108. In embodiments with more than one mobile device 108, the mobile devices 108 are not limited to one type of mobile device 108.

The abstraction device 102 enables communication of the data messages between the vehicle 106 and the mobile device 108 by converting input data messages between any one of multiple vehicle-specific formats and a standard mobile device format. The vehicle-specific format can be specific and proprietary to the make, model, and/or manufacturer of the vehicle 106. The conversion process performed by the abstraction device 102 enables the mobile device 108 to be vehicle-agnostic. As used herein “vehicle-agnostic” means that there is no pre-conditioned or pre-set functionality relating the mobile device 108 to the vehicle 106. Thus, regardless of the particular vehicle 106, the data messages communicated between the vehicle 106 and the mobile device 108 are properly formatted to be processed with host programs of the vehicle 106 and the mobile device 108.

The abstraction device 102 includes a mapping platform 112 configured to convert input data messages in the vehicle-specific format to output data messages in the standard mobile device format and to convert input data messages in the standard mobile device format to output data messages in the vehicle-specific format.

The standard mobile device format and the conversion of data messages between the standard mobile device format and one or more vehicle-specific formats may be defined by an application programming interface (hereinafter “API”). Some additional details of the mapping platform 112 and the API and/or other details that may be implemented in some embodiments described herein are disclosed in U.S. patent application Ser. No. 13/664,212, entitled “AUTOMOBILE DATA ABSTRACTION AND COMMUNICATION” and filed Oct. 30, 2012, which is incorporated herein by reference in its entirety.

The abstraction device 102 can perform conversions in a simple one-to-one mapping or in more complex mappings, examples of which are described herein. For example, an input data message can be received by the abstraction device 102. The input data message is communicated to the mapping platform 112 where the input data message is converted to the other format and then communicated from the abstraction device 102. Alternately or additionally, the abstraction device 102 can perform complex conversions. The complex conversions enable the abstraction device 102 to communicate the occurrence of more complex events in the output data messages communicated to the mobile device 108 and the vehicle 106. Some example of complex conversions include multiple input data messages being combined into one output data message; an input data message being evaluated until a predefined value or state of an event occurs; a first input data message being measured against a second input data message; an input data message being operated upon; multiple polls, requests, or commands sent to generate a single or compound data message, etc.

To perform the complex conversions, the abstraction device 102 includes an algorithmic logic unit (hereinafter “ALU”) 128 and a state machine 130. The ALU 128 receives some of the input data messages and performs algorithmic instructions thereon. By performing the algorithmic instructions, the ALU 128 generates an ALU output message. The ALU output message can include a result of the performance of the algorithmic instructions on the input data messages, the input data messages, or some representation of the result or the input data messages. The ALU output message is communicated to the mapping platform 112 where the ALU output message is converted to an output data message where it is formatted in the vehicle-specific format or the standard mobile device format. After formatting the output data message is communicated to the vehicle 106 or the mobile device 108.

The state machine 130 collects some of the input data messages and tracks a state of one or more events. When the state of the one or more event occurs as indicated by the input data messages, the state machine 130 communicates a state machine output message to the mapping platform 112. The state machine output message represents that the state of the one or more events has occurred and/or includes some of the input data messages. The mapping platform 112 converts the state machine output message to an output data message formatted in the vehicle-specific format or the standard mobile device format. The output data message is communicated the mobile device 108 or the vehicle 106.

In FIG. 1, the state machine 130 and the ALU 128 are depicted as distinct components in the abstraction device 102. However, in some embodiments, the state machine 130 and the ALU 128 may be physically incorporated in one module or subsystem or may be included in multiple other modules or subsystems. Additionally, the state machine 130 may perform some or all of the operations discussed above which are attributed to the ALU 128 and vice versa.

Different data messages, both input and output data messages, communicated between the vehicle 106 and the mobile device 108 are formatted differently and are communicated via differing communication channels. Generally, the format and the communication channel are based at least partially upon the function of the data message. For example, the input data messages that originate at the vehicle 106 generally represent automotive events. The automotive events indicate a state or change in state of one or more vehicle components/subsystems (hereinafter “vehicle components”) 110. For example, an automotive event may include, but is not limited to, a speed of the vehicle 106 as sensed by a speed sensor, a gear change sensed by a gear indicator, an air bag deploying, etc. The input data messages that originate at the vehicle 106 are formatted in the vehicle-specific format and are received by the mapping platform 112, the ALU 128, the state machine 130, or some combination thereof. The input data messages, some representation thereof, or some derivation thereof, are converted to the standard mobile device format in the mapping platform 112 and are communicated to the mobile device 108 via a mobile device transceiver 118 (in FIG. 1 “mobile device Tx/Rx”).

The input data messages that originate at the mobile device 108 can include write data messages that originate at the mobile application 120 and/or the mobile device subsystem 132. Some example of the input data messages originating at the mobile device 108 can include remote procedure call (hereinafter “RPC”) messages and/or application projection messages. When communicated to the vehicle components 110 through the abstraction device 102, the RPC messages can cause a subroutine or a procedure to be executed on one or more of the vehicle components 110 which can affect a condition of the corresponding vehicle components 110.

Each application projection message is a projection of a corresponding mobile application, such as the mobile application 120, installed on the mobile device 108 to the vehicle 106. Specifically, in some embodiments, the application projection messages are projected on a head unit display of the vehicle 106, such that the application projection messages are visible to an operator of the vehicle 106. These application projection messages may be rendered and displayed graphically in the vehicle 106. For example, the application projection messages may be displayed as an H.264 video stream decoded onto the head unit display of the vehicle 106.

The application projection messages are generally customized to project a user interface specific to vehicle applications. For example, to reduce distracted driving when projecting application projection messages to the head unit display, the user interface displayed on the head unit display is visually simpler and different from the mobile application 120 running on the mobile device 108.

Example details regarding projection of content, such as application projection messages, from a mobile device to a vehicle, and/or other details that may be implemented in some embodiments described herein are disclosed in U.S. patent application Ser. No. 13/664,204, entitled “PROJECTION OF CONTENT TO EXTERNAL DISPLAY DEVICES” and filed Oct. 30, 2012, which is incorporated herein by reference in its entirety.

The abstraction device 102 receives and transmits the input data messages using a vehicle transceiver 116 (in FIG. 1 “vehicle Tx/Rx”) and the mobile device transceiver 118. In some embodiments, the vehicle transceiver 116 is configured to physically connect to the CAN bus 104, such as through an on-board diagnostic (hereinafter “OBD”) connector. The OBD connector may be configured according to a standard such as OBD II, for instance. Also, the connection between the CAN bus 104 and the vehicle transceiver 116 might be a direct, wireless, or a hard-wired connection into one or more of the CAN busses 104 of the vehicle 106.

The mobile device transceiver 118 receives input data messages from the mobile device 108 and/or communicates output data messages to the mobile device 108. In some embodiments, the mobile device 108 includes the capability to transmit input data messages to the mobile device transceiver 118 via a wireless and/or a physical connection. Accordingly, the vehicle transceiver 116 may include Bluetooth, wireless fidelity (WiFi), high-definition mobile interface (HDMI), universal serial bus (USB), other Serial data communications, Mobile High Definition Link (MHL), third generation mobile telecommunication (3G), fourth generation mobile telecommunication (4G), long term evolution wireless communication (LTE), or any combination thereof sufficient to receive input data messages from the mobile device 108. In these and other embodiments, the connection between the mobile device 108 and the abstraction device 102 may be established via permissions, authentication of the mobile device 108, etc.

Likewise, output data messages communicated to the mobile device 108 from the abstraction device 102 may be transmitted via a wireless and/or a physical connection. In particular, in some embodiments, the mobile device transceiver 118 is configured to wirelessly transmit output data messages. Some mobile device transceivers 118 are specifically configured to broadcast output data messages. When broadcast, output data messages may be received by any mobile device, including the mobile device 108 and/or any similar device, configured to receive broadcasted output data messages.

Generally, the mobile application 120 and/or the mobile device subsystem 132 can be configured to incorporate one or more output data messages. Thus, when received by the mobile device 108, the output data messages are processed by the mobile application 120 and/or the mobile device subsystem 132 to provide one or more additional functionalities of the mobile application 120 and/or the mobile device subsystem 132.

For example, the mobile application 120 can be a navigation application configured to use GPS data received at the mobile device 108. The navigation application may additionally receive output data messages representing or derived from automotive events of the vehicle 106. The automotive events can include, but are not limited to, a speed of the vehicle 106, a real-time direction of the vehicle 106, acceleration of the vehicle 106, RPM of the engine of the vehicle 106, fuel consumption data of the vehicle 106, a precise radial position of a steering wheel of the vehicle 106, rotational values for each of the tires of the vehicle 106, etc. The navigation application may process output data messages representative of, related to, or derived from one or more of these automotive events to provide additional and/or improved functionality in the navigation application.

As mentioned above, the navigation application can then communicate application projection messages from the navigation application, including additional and/or improved functionality, to a vehicle component 110 such as a head unit display. The application projection messages communicated from the navigation application can include real-time navigation data and/or can include encoded information to display real-time video streams of a navigation user interface generated by the navigation application, for instance.

Additionally, in some embodiments, the input data messages representing the automotive events may be transmitted through the abstraction device 102 and to the mobile device 108 prior to display on one or more of the vehicle components 110 included in the vehicle 106. The transmission of the input data messages representing the automotive events through the abstraction device 102 and to the mobile device 108 enables the mobile application 120 to process the output data messages representing or derived from the automotive events prior to display on the vehicle component 110 of the vehicle 106. The mobile application 120 and/or the mobile device subsystem 132 receives and incorporates the output data messages and communicates input data messages including the additional and/or improved functionalities. Thus, the operator views the additional and/or improved functionalities provided by the mobile application 120 and/or the mobile device subsystem 132 without first viewing the unprocessed automotive events.

For example, the vehicle 106 can have a local navigation application installed by the manufacturer on the vehicle 106 that makes use of the head unit display. The mobile application 120 can be a mobile navigation application. The abstraction device 102 can be configured to abstract automotive events related to navigation (discussed above) and communicate the automotive events to the mobile device 108 prior to use by the local navigation application. The mobile application 120 uses the automotive events to project an updated, alternative, and/or enhanced navigation application to the operator on the head unit display.

In some embodiments, in addition to the automotive events being communicated to the mobile device 108, the abstraction device 102 enables an operator to input control data messages to the mobile application 120 and/or the mobile device subsystem 132 via the one or more vehicle components 110. These vehicle components 110 are generally referred to as human-machine interfaces (hereinafter “HMI”). In these and other embodiments, the control data messages are received by the mobile device 108 and executed by the mobile application 120 and/or the mobile device subsystem 132. The result of the control data messages executed on the mobile application 120 and/or the mobile device subsystem 132 is communicated back to and reflected on the vehicle component 110 via the abstraction device 102. For example, the mobile application 120 can be a mobile navigation application configured to receive automotive events related to navigation. Additionally, the vehicle components 110 can include a head unit display with a touch user interface, a microphone for voice command input, and/or a steering wheel with physical pushbuttons, for instance. The operator can input a destination control data message to the mobile device 108 by operating the head unit display, announcing voice commands via the microphone, and/or depressing the pushbuttons on the steering wheel. The mobile navigation application processes the destination and communicates directions, etc. via the abstraction device 102 which are displayed to the head unit display.

The abstraction device 102 also includes a subscription module 126, a filter 124, and a certification module 122. Each of the subscription module 126, the filter 124, and the certification module 122 variously interface with the vehicle transceiver 116, the mobile device transceiver 118, and the mapping platform 112 as illustrated in FIG. 1.

The subscription module 126 is configured to enable selection of one or more subsets of information represented by the data messages communicated between the vehicle 106 and the mobile device 108. The mobile device 108, the vehicle 106, operators thereof, or subsystems included therein can communicate with the subscription module 126 to select one or more of the data messages. Specifically, the abstraction device 102 may abstract input data messages pertaining to a wide variety of the vehicle components 110. In some embodiments, only a subset of these input data messages may be processed and/or used by the mobile application 120 and/or the mobile device subsystem 132. Accordingly, a subset of the input data messages as specified in the subscription module 126 are communicated between the vehicle 106 and the mobile device 108 and the remaining input data messages are discarded. Likewise, the mobile device 108 can communicate a wide variety of input data messages. Some of these input data messages are harmful to the vehicle 106 or are otherwise not supported by the vehicle 106. Accordingly, a subset of these input data messages as specified in the subscription module 126 are communicated from the mobile device 108 to the vehicle 106, while the remaining input data messages are discarded.

As depicted in FIG. 1, the mobile device 108 and the vehicle 106 select input in the subscription module 126. In FIG. 1, a first arrow representing the selection by the mobile device 108 (as well as an operator thereof and subsystem thereon) connects the mobile device 108 to the subscription module 126. Additionally, a second arrow representing the selection by the vehicle 106 (as well as an operator thereof and subsystem thereon) connects the vehicle 106 to the subscription module 126. This depiction is not meant to be limiting. It should be appreciated with the benefit of this disclosure that the mobile device 108 and the vehicle 106 can communicate with the subscription module 126 via the mobile device transceiver 118 and the vehicle transceiver 116, respectively.

The filter 124 is configured to receive the selection from the subscription module 126 and to enable bi-directional filtering of data messages communicated between the vehicle 106 and the mobile device 108. For example, to determine a subset of the data messages that are communicated to the mobile device 108, the data messages not included in the selection by the mobile device 108 can be filtered from all the input data messages received from the vehicle 106. Similarly, to determine a second subset of the data messages that are communicated to the vehicle 106, the input data messages not included in the selection by the vehicle 106 can be filtered from all the data messages received from the mobile device 108.

In some embodiments, the filter 124 is configured to receive data messages following conversion in the mapping platform 112. Alternatively, the filter 124 can receive data messages prior to the conversion in the mapping platform 112. There is some tradeoff between efficiency of the mapping platform 112 and the complexity of the filter 124 between these configurations. For example, there can be some benefit to filtering the data messages following conversion due to the simplicity of the filter 124. However, in this embodiment the abstraction device 102 wastes energy converting data messages that are discarded. In the alternative embodiment in which the filter 124 filters the data messages prior to conversion in the mapping platform 112, the filter 124 is more complex because the filter 124 filters data messages formatted in multiple vehicle-specific formats. Thus, the filter 124 includes additional complexity to read the multiple vehicle-specific formats. However, the abstraction device 102 may be more efficient because the abstraction device 102 only converts data messages that are communicated.

Additionally, in some embodiments, the certification module 122 interfaces with the filter 124 and the subscription module 126 to further restrict data messages communicated between the vehicle 106 and the mobile device 108. Generally, the certification module 122 is configured to verify read privileges and/or write privileges of the mobile device 108 or an operator of the mobile device 108 at a particular time. The read privileges generally allow the mobile device 108 to receive certain data messages and the write privileges generally allow the mobile device 108 to transmit certain data messages to the vehicle 106 and/or to one or more of the vehicle components 110.

The read privileges can be based on the operator, the mobile device 108, the mobile application 120, a license within the mobile application, any combination thereof, or any similar characteristic Likewise, the write privileges can be based on the operator, the mobile device 108, the mobile application 120, a license within the mobile application, any combination thereof, or any similar characteristic. Additionally, the write privileges can be based on the state of other data messages. For example, a read privilege may prohibit a mobile device 108 operated by a second operator from receiving data messages from a vehicle 106 owned by a first operator. Additionally or alternatively, a read privilege may prohibit an operator who is a relatively new operator from accessing proprietary information. Additionally or alternatively, an operator, who is a relatively new operator, may not have write privileges to deploy an airbag at all. Additionally or alternatively, a vehicle mechanic may not have write privileges to deploy the airbag while the vehicle 106 is operating.

The filter 124 and/or the subscription module 126 interface with the certification module 122 to further restrict communication of data messages based on the read and/or write privileges. For example, the data messages transmitted by the mobile device transceiver 118 can be based on the selection made in the subscription module 126 and a read privilege. Thus, for the mobile device 108 to receive a first data message, for instance, the mobile device 108 may have previously selected the first data message in the subscription module 126 and the mobile device 108 must have the read privilege as verified by the certification module 122. In some embodiments, the certification module 122 verifies read and/or write privileges in the subscription module 126.

In alternative embodiments, the certification module 122 receives data messages after the mapping platform 112 has converted the data messages from the standard mobile device format to the vehicle-specific format or vice versa. The certification module 122 can act as a second filter, but rather than filtering based on selections in the subscription module 126, the certification module 122 filters based on read and/or write privileges.

In some embodiments in which the certification module 122 verifies read and/or write privileges in the subscription module 126, the certification module 122 can restrict available data messages from which the mobile device 108 or the vehicle 106 can select. In these and other embodiments, an operator may only be able to view the data messages that are available to the operator based upon the operator's read and/or write privilege.

In alternative embodiments, the certification module 122 receives data messages after the filter 124 filters data messages not selected by the mobile device 108 or the vehicle 106. In these and other embodiments, the certification module 122 verifies the read and/or write privilege prior to communication by the vehicle transceiver 116 and/or conversion by the mapping platform 112, for instance.

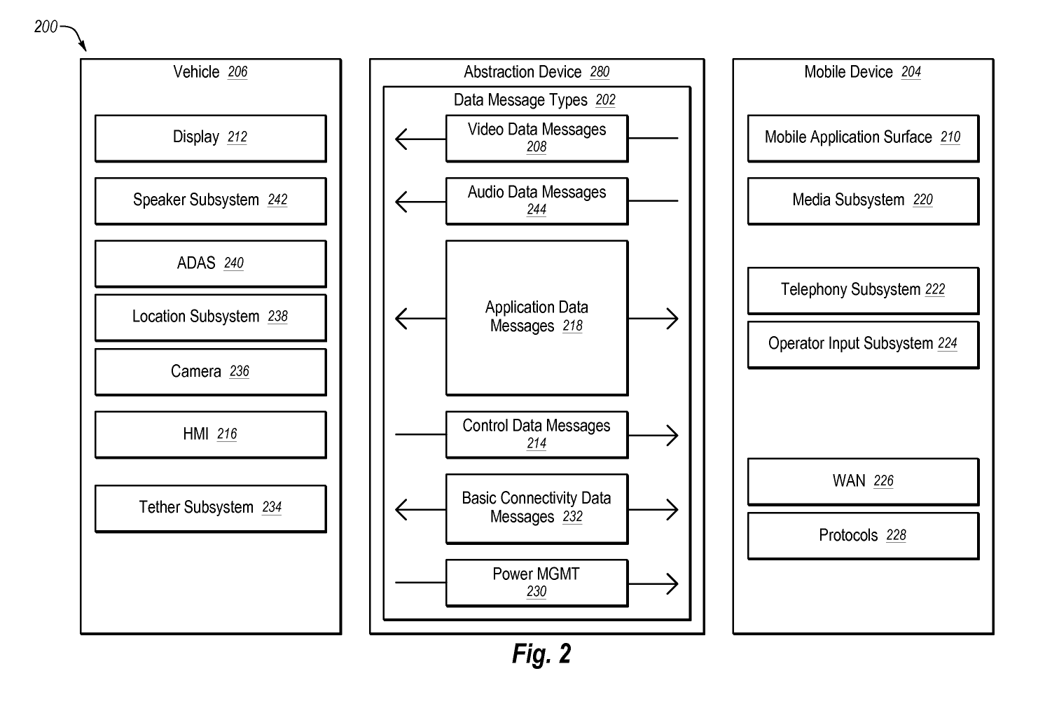

FIG. 2 is a block diagram of an example software stack 200 that can be implemented in the system 100 of FIG. 1. The software stack 200 illustrates multiple data message types 202 communicated between a mobile device 204 and a vehicle 206 through an abstraction device 280. The mobile device 204, the vehicle 206, and the abstraction device 280 are substantially similar to and/or correspond to the mobile device 108, the vehicle 106, and the abstraction device 102 of FIG. 1. The mobile device 204 includes multiple mobile device subsystems (e.g., 210, 220, 222, 224, 226, and 228). The vehicle 206 includes multiple vehicle subsystems (e.g., 212, 242, 240, 238, 236, and 216). Each of the mobile device subsystems and the vehicle subsystems can transmit and/or receive data messages. Additionally some data message types 202 can be received generally by the mobile device 204 or the vehicle 206.

The data message types 202 are represented in FIG. 2 by boxes 208, 244, 218, 214, 232, and 230. Each of the boxes 208, 244, 218, 214, 232, and 230 includes at least one arrow indicating a direction in which the data message type 202 is generally communicated. For example, a video data message 208 may be communicated from a mobile application surface 210 to one or more displays 212. Likewise, a command data message 214 may be communicated from an HMI 216 to one or more mobile device subsystems. Also, application data messages 218 are communicated from one or more mobile device subsystems (222 and 224) to the vehicle subsystems (240, 238, and 236) and vice versa.

As discussed with reference to FIG. 1, generally the data messages that originate at the vehicle 206 represent automotive events and the data messages that originate at the mobile device 204 can represent write data messages such as RPC messages and/or application projection messages. The embodiment depicted in FIG. 2 is more particular, depicting origins and functions of data messages characterized by data message type 202 according to an example embodiment. Specifically, the data message types 202 included in FIG. 2 include the video data messages 208, audio data messages 244, application data messages 218, control data messages 214, basic connectivity data messages 232, and power management data messages (in FIG. 2, “Power MGMT”) 230. Each of the data message types 202 are briefly discussed below.

The video data messages 208 are generally similar to and may correspond to the application projection messages discussed with reference to FIG. 1. The video data messages 208 are communicated to the displays 212. The displays 212 can include, but are not limited to, a center console display, an instrument cluster display, a heads-up display (HUD), and a rearview minor display. The mobile application surface 210 generally refers to the user interface displayed to an operator of the mobile device 204. The mobile application surface 210 may not be identical to the content of the video data messages 208 communicated to the display 212. For example, the video data messages 208 may include a simplified version of the user interface displayed to the operator.

The audio data messages 244 are communicated from a media subsystem 220. The media subsystem 220 can include various media information such as metadata related to media files, an audio stream received by the media subsystem 220 and/or actions taken by the operator related to the audio files in the media subsystem 220. The audio data messages 244 can include any of the media information or any other information included in the media subsystem 220. The audio messages 244 are communicated to the speaker subsystems 242 where the audio data messages 244 are played for the operator or incorporated into one or more radio systems. The radio systems can include AM, FM, and/or satellite radio systems, for instance.

The application data messages 218 include data that can be communicated between one or more of the mobile device subsystems and one or more of the vehicle subsystems for processing in one or more applications. For example, the application data messages 218 can include data originating at a location subsystem 238. More specifically, the location subsystem 238 can include a GPS, a dead reckoning system, rates of tire rotations, wheel positions, compasses, accelerator position, etc. The application data messages 218 that originate at location subsystem 238 can be communicated to one or more mobile device subsystems for processing in a mobile application such as a navigation application (not shown).

In FIG. 2, the application data messages 218 communicated from the vehicle 206 to the mobile device 204 can alternately or additionally originate in an advanced driver assistance system 240 (hereinafter “ADAS”), the location subsystem 238, and/or a camera 236. The application data messages 218 communicated from the mobile device 204 to the vehicle 206 can originate at a telephony subsystem 222 and/or an operator input subsystem 224. Like the example above, each of the application data messages 218 are communicated and processed in an application where the application data messages 218 are received. These subsystems (e.g., 240, 238, 236, 222, and 224) in which the general data messages 218 originate are illustrative and not limiting.

The control data messages 212 can originate at an HMI subsystem 216. As discussed with reference to FIG. 1, the HMI 216 can include specific HMIs such as buttons, dials, D-pads, volume controls, and/or a microphone. The operator of the vehicle 206 can use the HMI 216 to generate control data messages 214 that are communicated to one or more mobile device subsystems. The control data messages 214 are processed at the one or more mobile device subsystems as if generated locally at the mobile device 204.

The basic connectivity data messages 232 can originate at either vehicle 206 or mobile device 204. The basic connectivity data messages 232 refer to basic communication on various channels established between the mobile device 204 and the vehicle 206 and/or the status of the channels. For example, the channels can include, but are not limited to, a Bluetooth communication channel, a WiFi communication channel, and a physical pluggable communication channel.

The vehicle 206 may include a tether subsystem 234. Tethering generally refers to a link to a computer network by the vehicle 206 through the mobile device 204. Accordingly, the tether subsystem 234 enables communication with a computer network via a wide area network (hereinafter “WAN”) subsystem 226. To establish and monitor the status of the channels, protocols 228 are communicated between the vehicle 206 and the mobile device 204. The protocols 228 can include Bluetooth communications protocols, TCP/IP protocols, WiFi protocols, serial protocols, or the like or any combination thereof.

The power management data messages 230 relate to powering the mobile device 204 through a physical connection between the vehicle 206 and the mobile device 204. The power management data messages 230 can be received by the mobile device 204 and displayed to the operator.

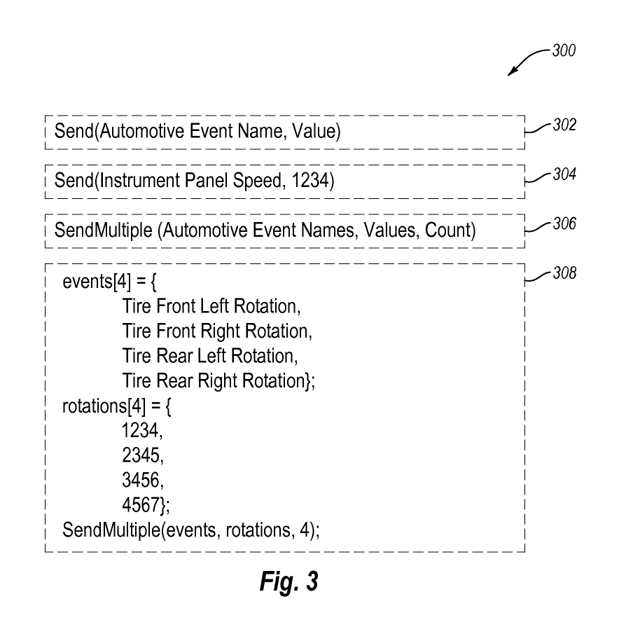

FIG. 3 illustrates some example output data messages 300 representing automotive events that may be communicated in the system 100 of FIG. 1. The output data messages 300 include a single automotive event format 302. With combined reference to FIGS. 1 and 3, in the single automotive event format 302, a single automotive event may be communicated from the vehicle 106 to the mobile device 108. More specifically, the abstraction device 102 receives an automotive event, which is formatted in a vehicle-specific format, and converts the automotive event into the single automotive event format 302. The single automotive event format 302 represents the automotive event in the standard mobile device format.

An example speed data message 304 is included in the example output data messages 300 of FIG. 3. The speed data message 304 is an example of an automotive event (i.e., speed) formatted in the single automotive event format 302. Namely, the “Automotive Event Name” of the single automotive event format 302 corresponds to a specific automotive event “Instrument Panel Speed” in the speed data message 304. Likewise, the “Value” of the single automotive event format 302 corresponds to a specific value of “1234” in the speed data message 304. The speed data message 304 is only one example of data messages that can be communicated between the vehicle 106 and the mobile device 108.

Additionally, FIG. 3 depicts a multiple automotive event format 306. In the multiple automotive event format 306, multiple automotive events may be communicated from the vehicle 106 to the mobile device 108. More specifically, the abstraction device 102 receives multiple automotive events formatted in a vehicle-specific format. The abstraction device 102 converts the automotive events into the multiple automotive event format 306 and communicates the automotive events to the mobile device 108. The multiple automotive event format 306 represents the automotive events in the standard mobile device format.

An example multiple tire rotation data message 308 is included in the example data messages 300 of FIG. 3. The multiple tire rotation data message 308 is an example of multiple automotive events formatted in the multiple automotive event format 306. Namely, the “Automotive Event Names” of the multiple automotive event format 306 corresponds to specific automotive events defined by a first variable “events[4]”. The first variable is defined as “Tire Front Left Rotation”, “Tire Front Right Rotation”, “Tire Rear Left Rotation”, and “Tire Rear Left Rotation” in the multiple tire rotation data message 308. Likewise, the “Values” of the multiple automotive event format 306 corresponds to specific values defined by a second variable “rotations [4]”. The second variable is defined as “1234”, “2345”, “3456”, and “4567” in the multiple tire rotation data message 308. The “Count” of the multiple automotive event format 306 is defined as “4” in the multiple tire rotation data message 308. Using the multiple tire rotation data message 308, the values (i.e., 1234, 2345, 3456, and 4567) for each of the automotive events (i.e., Tire Front Left Rotation, Tire Front Right Rotation, Tire Rear Left Rotation, and Tire Rear Left Rotation) are communicated to the mobile device 108 by the message “SendMultiple (events, rotations, 4)” at once rather than communicating four different data messages formatted according to the single automotive event format 302. The tire rotation multiple data message 308 is only one example of data messages that can be communicated between the vehicle 106 and the mobile device 108.

Some automotive events may be more complex to track and may not be automatically generated upon change of automotive state. In these and other embodiments, a state machine and/or algorithmic logic may be used to collect and track automotive events and to generate a mobile device message only when the appropriate state and/or algorithmic conditions are met, as already described above. In some embodiments, multiple polls, requests, and/or commands to the corresponding CAN bus along with storage and algorithmic logic may be required to generate a single or compound message to the mobile device.

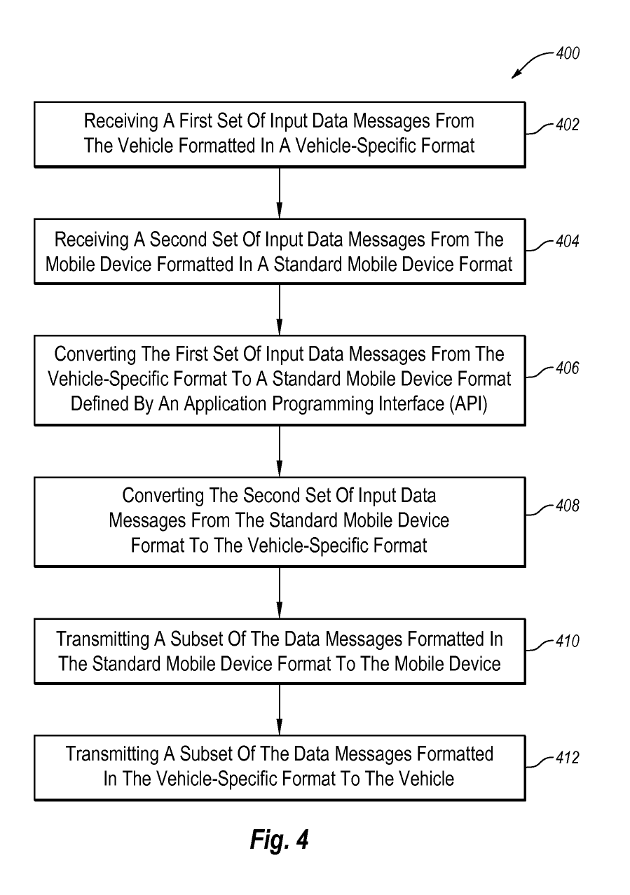

FIG. 4 is a flow chart of an example method 400 of communication between a mobile device and a vehicle, arranged in accordance with at least some embodiments described herein. The method 400 may be performed, in some embodiments, by an abstraction device, such as the abstraction device 102 of FIG. 1. Although illustrated as discrete blocks, various blocks may be divided into additional blocks, combined into fewer blocks, or eliminated, depending on the desired implementation.

The method 400 begins at 402 by receiving a first set of input data messages from the vehicle. The first set of input data messages are formatted in a vehicle-specific format. One or more of the data messages included in the first set of input data messages represent automotive events. The first set of input data messages can include input data messages having any of multiple data message types. For example, the first set of input data messages can include application data messages, control data messages, basic connectivity data messages, power management data messages, or any combination thereof.

At 404, a second set of input data messages is received from the mobile device formatted in a standard mobile device format. The second set of input data messages can have any of multiple data message types. For example, the second set of input data messages can include application data messages, video data messages, audio data messages, basic connectivity data messages, or any combination thereof.

At 406, the first set of input data messages is converted from the vehicle-specific format to a standard mobile device format defined by an API. At 408, the second set of input data messages are converted from the standard mobile device format to the vehicle-specific format.

At 410, a subset of the data messages formatted in the standard mobile device format is transmitted to the mobile device. At 412, a subset of the data messages formatted in the vehicle-specific format is transmitted to the vehicle. The subset of the data messages formatted in the standard mobile device format is configured to be processed by the mobile device to provide additional functionality in a mobile application or a mobile device subsystem. In some embodiments, the subset of data messages formatted in the standard mobile device format is broadcast such that any mobile device may receive the subset of the data messages formatted in the standard mobile device format.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For instance, the method 400 may further include enabling the mobile device to select which of the data messages formatted in the standard mobile device format to transmit to the mobile device and enabling the vehicle to select which of the data messages formatted in the vehicle-specific format to transmit to the vehicle.

Additionally or alternatively, the method 400 may further include collecting a subset of the first set of input data messages. A state of an event can be tracked. When the state of the event occurs as indicated by the subset of the first set of input data messages, a state machine output message representing that the state of the event has occurred is generated. The state machine output message is converted to an output data message.

Additionally or alternatively, the method 400 may further include receiving a subset of the first set of the input data messages. Algorithmic instructions are performed on the subset of the first set of the input data messages. From the performance of the algorithmic instructions an ALU output message is generated that is converted to an output data message.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible computer-readable storage media including random-access memory (RAM), read-only memory (ROM), electrically erasable programmable read-only memory (EEPROM), compact disc read-only memory (CD-ROM) or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions include, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A data abstraction and communication device comprising:
a mapping platform configured to:
convert input data messages formatted in a vehicle-specific format to output data messages formatted in a standard mobile device format, the input data messages formatted in the vehicle-specific format having any of a first plurality of data message types and being received from a plurality of vehicle subsystems, and
convert input data messages formatted in the standard mobile device format to output data messages in the vehicle-specific format, the input data messages formatted in the standard mobile device format having any of a second plurality of data message types and being received from a plurality of mobile device subsystems;
a vehicle transceiver configured to transmit the output data messages formatted in the vehicle-specific format to a vehicle via a controller area network (CAN) bus of the vehicle; and
a mobile device transceiver configured to transmit the output data messages formatted in the standard mobile device format to a mobile device.

2. The data abstraction and communication device of claim 1, further comprising:
an algorithmic logic unit (ALU) configured to receive a first plurality of the input data messages and to perform algorithmic instructions on the first plurality of the input data messages to generate an ALU output message that is communicated to the mapping platform, and
wherein the mapping platform is further configured to convert the ALU output message to an output data message formatted in the vehicle-specific format or the standard mobile device format.

3. The data abstraction and communication device of claim 2, wherein the ALU output message includes a result of the performance of the algorithmic instructions on the first plurality of input data messages, a subset of the first plurality of the input data messages, or a representation of the result of the performance of the algorithmic instructions on the first plurality of the input data messages.

4. The data abstraction and communication device of claim 2, further comprising:
a state machine configured to collect a second plurality of input data messages and to track a state of an event, wherein when the state of the event occurs as indicated by the second plurality of input data messages, the state machine is configured to communicate a state machine output message representing that the state of the event has occurred to the mapping platform, and
wherein the mapping platform is further configured to convert the state machine output message to an output data message formatted in the vehicle-specific format or the standard mobile device format.

5. The data abstraction and communication device of claim 1, wherein the first plurality of data message types comprises a control data message and an application data message.

6. The data abstraction and communication device of claim 5, wherein the application data message is communicated from a location subsystem of the vehicle.

7. The data abstraction and communication device of claim 5, wherein the second plurality of data message types comprises a video data message and a second application data message.

8. A data abstraction and communication device configured to communicate a subset of data messages between a vehicle and a mobile device, the data abstraction and communication device comprising:
a subscription module configured to enable selection of one or more subsets of information represented by data messages communicated between the vehicle and the mobile device;
a filter configured to receive the selection from the subscription module and to enable bi-directional filtering of the data messages communicated between the vehicle and the mobile device;
a certification module configured to verify read privileges or write privileges of the mobile device and to interface with the subscription module and the filter to further restrict communication of data messages between the mobile device and the vehicle;
a mapping platform configured to convert a first plurality of input data messages from a vehicle-specific format to output data messages formatted in a standard mobile device format and to convert a second plurality of input data messages from the standard mobile device format to output data messages formatted in the vehicle-specific format;
a mobile device transceiver configured to transmit a subset of the output data messages formatted in the standard mobile device format from the data abstraction and communication device to the mobile device; and
a vehicle transceiver configured to transmit a second subset of the output data messages formatted in the vehicle-specific format from the data abstraction and communication device to the vehicle via a controller area network (CAN) bus of the vehicle.

9. The data abstraction and communication device of claim 8, wherein the subset of the output data messages is based on the selection made in the subscription module and a read privilege of the mobile device verified by the certification module.

10. The data abstraction and communication device of claim 8, wherein the second subset of the output data messages is based on the selection made in the subscription module and a write privilege of the mobile device verified by the certification module.

11. The data abstraction and communication device of claim 8, wherein:
the input data messages formatted in the vehicle-specific format include a first plurality of data message types communicated from a plurality of vehicle subsystems; and
the input data messages formatted in the standard mobile device format include a second plurality of data message types communicated from a plurality of mobile device subsystems.

12. The data abstraction and communication device of claim 11, wherein:
the first plurality of data message types comprises a control data message and an application data message that represent automotive events; and
the second plurality of data message types comprises a video data message and a second application data message.

13. The data abstraction and communication device of claim 8, wherein:
the first plurality of input data messages represent automotive events communicated to the data abstraction and communication device from the vehicle via the CAN bus; and
the second plurality of input data messages represent write data messages communicated to the data abstraction and communication device from the mobile device.

14. The data abstraction and communication device of claim 13, wherein the write data messages comprise a remote procedure call (RPC) message configured to cause a subroutine or a procedure to be executed to affect a condition of a vehicle component or an application projection message configured to project a display of a mobile application installed on the mobile device onto a display in the vehicle.

15. The data abstraction and communication device of claim 8, wherein at least one of the output data messages formatted in the standard mobile device format includes information of two or more automotive events, each of the automotive events representing a state or change in state of a vehicle component.

16. A method of communicating data messages between a mobile device and a vehicle, the method comprising:
receiving a first plurality of input data messages from the vehicle formatted in a vehicle-specific format;
receiving a second plurality of input data messages from the mobile device formatted in a standard mobile device format;
converting the first plurality of input data messages from the vehicle-specific format to a standard mobile device format defined by an application programming interface (API);
converting the second plurality of input data messages from the standard mobile device format to the vehicle-specific format;
transmitting a subset of the data messages formatted in the standard mobile device format to the mobile device; and
transmitting a subset of the data messages formatted in the vehicle-specific format to the vehicle.

17. The method of claim 16, wherein:
the first plurality of input data messages comprises input data messages including a first plurality of data message types; and
the second plurality of input data message comprises input data messages including a second plurality of data message types.

18. The method of claim 16, further comprising:
enabling the mobile device to select the subset of the output data messages formatted in the standard mobile device format to transmit; and
enabling the vehicle to select the subset of the output data messages formatted in the vehicle-specific format to transmit.

19. The method of claim 16, further comprising:
collecting a subset of the first plurality of input data messages;
tracking a state of an event; and
when the state of the event occurs as indicated by the subset of the first plurality of input data messages, communicating a state machine output message representing that the state of the event has occurred.

20. The method of claim 16, further comprising:
receiving a subset of the first plurality of the input data messages;
performing algorithmic instructions on the subset of the first plurality of the input data messages; and
generating an ALU output message that is converted to an output data message.
